(19) United States
(12) Patent Application Publication
(10) Pub. No.: US 2023/0298150 A1
(43) Pub. Date: Sep. 21, 2023

(54) AUTOMATIC AND GUIDED INTERIOR INSPECTION

(71) Applicant: Diehl Aerospace GmbH, Ueberlingen (DE)

(72) Inventors: Lothar TRUNK, Weibersbrunn (DE); Stefan MUELLER-DIVEKY, Schoeneck (DE); Tobias GUT, Ueberlingen (DE)

(73) Assignee: Diehl Aerospace GmbH, Ueberlingen (DE)

(21) Appl. No.: 18/121,067

(22) Filed: Mar. 14, 2023

(30) Foreign Application Priority Data
Mar. 18, 2022 (DE) 102022106352.6

(51) Int. Cl. G06T 7/00; G06V 10/764; G06V 20/59

(52) U.S. Cl. CPC G06T 7/0002; G06V 10/764; G06V 20/59; G06T 2207/30268

(57) ABSTRACT

An inspection arrangement (8) for an interior (4) with objects (6) of a passenger vehicle (2) contains an image recording unit (10a-c) for an image (18) of the interior (4) of the vehicle (2) with the object (6), a classification database (20) with classification values (22) for the objects (6) and assignment rules (24) for assigning the classification values (22) to specific image contents (26) depicting the objects (6), an image analysis unit (28) which is connected to the database (20) in order to automatically analyse the image contents (26) and to assign classification values (22) according to the assignment rules (24), and interfaces (30a,b) for the input and/or output of classification values (22) and/or images (18) from and/or to a downstream entity (34).

In an inspection method with the aid of the inspection arrangement (8), an image (18) is recorded, the image content (26) analysed automatically using the database (20) by the analysis unit (28), and classification values (22) assigned with the aid of the assignment rules (24) to the image content (26), and the classification values (22) assigned to the image (18), and optionally also the image (18), are output via the interfaces (30a,b) to a downstream entity (34) and/or input.

### BACKGROUND OF THE INVENTION

The invention relates to inspection of an interior of a passenger vehicle. The latter is to be understood as vehicles for transporting in particular a large number of passengers, such as, for example, a passenger aircraft, a passenger ship, a coach or a passenger carriage of a train (railway, tram, underground train and the like). This interior contains a large number of objects such as seats, tables, wall coverings, electrical equipment and their respective parts such as seat cushions, charging sockets, etc.

The background to the present invention will be explained below as representative for all vehicles on the example of a passenger aircraft:

### DISCUSSION OF THE PRIOR ART

The following is known from the prior art: such inspections (“cabin inspection” in the case of passenger aircraft) are today carried out manually by specially trained personnel looking through the cabin and the objects situated therein systematically for anomalies/damage such as scratches, breakages, dirt, etc. Anomalies/abnormalities are passed on to the manufacturer of the objects, in this case cabin equipment, and are dealt with by them. This process is prone to error, is subjective and entails a lot of effort from the personnel.

Detecting anomalies/defects in the cabin is currently a manual process in which according to the invention more than 80% of the anomalies/defects are recorded by maintenance personnel. The remaining anomalies/defects are found and reported by cabin crew during a flight. Checking the cabin/objects for cosmetic anomalies/defects and that they are functional requires trained personnel who carry out visual inspections and functional checks of each seat and cabin item as objects as part of daily, weekly and monthly checks. Thus, for example, objects such as USB charging ports, lighting, pneumatic seat cushions and actuators are checked by individually checking each seat in a time-intensive fashion. In the case of wide-bodied aircraft with more than 400 seats, at least four people at one time are scheduled.

### SUMMARY OF THE INVENTION

The present invention is directed to improvements with respect to an inspection of this type.

In accordance with present invention, an inspection arrangement for an interior of a passenger vehicle which contains at least one and in particular a large number of objects is provided. A corresponding interior with objects is thus assumed for the present invention. In other words, the inspection arrangement is designed/configured for such specified interiors with objects which are known within this meaning.

The inspection arrangement contains at least one image recording unit (“recording unit” for short). This recording unit is configured to record a respective image of the interior of the vehicle with the object. The image contains specified image content, namely the (complete or partial) depiction of one or more objects, for example an aircraft seat, its seat cushion, a folding table, a wall covering, a charging socket, etc. “Specified” means that the invention is based on such images and is configured for such images. An anomaly on the object may thus be depicted.

The inspection arrangement contains a classification database (“database” for short). This database contains classification values for at least one of the objects and assignment rules. It is assumed here that the objects are those which would be expected to be found in the interior and are depicted on images. In this respect, the database is configured and set up for a large number of objects to be expected. The assignment rules describe that specific image content of images is assigned specific classification values. The image content here depicts at least part of one or more objects. In particular, the image content is a depicted anomaly on the object, for example a scratch. For example, one of the rules states that image content in the form of a depiction of a 4.5 cm long scratch on a covering or a screen is assigned the classification value “4.5 cm long scratch”. Because the object is depicted, the classification value is thus also assigned to the depicted object and to the image. In particular, one of the classification values can also be zero, for example when no anomalies/objects to be classified or properties of the latter to be classified are contained and depicted in an image. The zero value then corresponds to a statement “no abnormalities found in the image content”/“everything OK” or the like and is assigned, for example, to such an image/object depicted therein. This then corresponds conceptually to an alternative in which no classification value would be assigned to an image. The classification values thus serve to classify an anomaly on an object in the interior and assign it to the anomaly/object/image.

The inspection arrangement contains an image analysis unit (“analysis unit” for short). This analysis unit is connected, at least unidirectionally, to the database communicatively, i.e. for data and information exchange. The analysis unit is configured to automatically analyse the images in terms of the image content/depicted objects and to assign classification values to the images with the relevant image content/depiction of an object and possibly the anomaly in accordance with the assignment rules. Generally speaking, a classification value is assigned to a single image/object/anomaly but it can also be assigned to multiple images when, for example, the images have correlated image content, for example show the same object with the anomaly from multiple viewpoints. In particular, an anomaly depicted in the image on an object is automatically classified by the classification value describing the anomaly being assigned automatically to it and hence to the object and the image.

The inspection arrangement contains at least one interface. These interfaces serve for the input and/or output of data/information into and from the inspection arrangement. The input/output is effected from and to a downstream entity. This downstream entity can be an external system, in particular a data-processing device, which is different from the inspection arrangement, a user, or alternatively a hitherto unmentioned component of the inspection arrangement (see below). In particular, the interfaces serve to input and output images and/or classification values assigned to the images or to a specific image/image content/object/anomaly (including an identification code or another reference to the relevant image, or the image itself).

Input via the interface is to be understood in particular as meaning that the downstream entity inputs modified/corrected (previously output via the interface) or additional (new) classification values (see below). In the case of images, in particular only output takes place and not input. A location value (for example, a seat number) describing a location of the object in the interior, or an image marking (for example rows, columns in a digital image) describing a marking location in the image.

The image is in particular a still image but can also be a moving image (video/film), for which reason in the present case “image” should also be understood as an image sequence in the form of a film.

The recording unit generates in particular images in different spectral ranges, for example with visible light, infrared light, etc. The analysis unit serves in particular to compare a target or standard state (for example, undamaged seat, i.e. with no anomaly) with an actual state (seat has an anomaly, for example dirt or a tear in the seat cover) with the aid of the images or image content and to assign corresponding classification values (type, location, extent of the dirt or size of the tear on the seat and in the image). It is in particular assumed here that the target state of an object (without an anomaly) is known in the database/inspection arrangement.

The database maps in particular expert knowledge and classification criteria. The database thus corresponds in particular to an anomaly/defect database. Its content describes, for example, how anomalies/defects on objects (scratches in walls, tears in sets) “look” in the images in the form of image contents and can be recognized by the analysis unit. In particular, recognition algorithms for anomalies/damage, the classification thereof and recommended actions for dealing with correspondingly classified anomalies/events/states, are implemented in the database in conjunction with the analysis unit. The database can therefore also be referred to as a “recognition database”. Inputs via the interface serve in particular also to expand the content of the database.

The detection, processing and repairing of anomalies/deficiencies, defects, peculiarities, etc on objects are simplified, improved and accelerated thanks to the inspection arrangement.

In a preferred embodiment, the classification value is one of the following: an object value identifying one of the objects, for example “seat”, “backrest”, “covering panel”, etc. A location value describing a location of the object in the interior, for example a seat number of a passenger seat, a description of a covering panel (for example, “on the left, third from the front”). A problem value describing a problem on the object, for example “tear in sitting surface”, “scratch on the screen”, etc. A problem classification value classifying the problem, for example “can be seen/can just be seen/cannot be seen by passengers”. A repair value correlated with the repair of the problem on the object, for example “as soon as possible”, “at next routine maintenance”, etc. An image attribute value describing an attribute of the image, for example ID of a person or a camera who or which has taken the image, date taken, ID of the vehicle, etc. An image marking describing a marking location in the image, for example row range from . . . to . . . , column range from . . . to . . . , etc.

Such classification values enable many possible anomalies/defects, peculiarities, etc on objects to be detected, classified and described precisely.

In a preferred embodiment, the inspection arrangement contains an image processing unit interposed between the recording unit and the analysis unit. It is configured to carry out image processing on the images generated by the recording unit before the processed images are transmitted to the analysis unit. However, zero processing can also take place here, i.e. the recorded image can be forwarded unmodified. The quality of the classification (accuracy, speed, . . . ) can be improved by corresponding image processing.

In a preferred embodiment, at least one of the recording units is a recording unit which is to be fixedly attached in the vehicle as specified. It is thus intended for fixed installation and is actually fixedly installed when in use. It is here in particular a camera fixedly installed in the vehicle, in particular in the interior. The camera is installed, for example, on the ceiling of a passenger cabin and therefore looks down “from above” into the passenger cabin. It is consequently particularly simple to assign locations of classifications.

In a preferred embodiment, at least one of the recording units is a recording unit which can be deployed movably in the vehicle. In contrast to above, the recording unit is not installed fixedly in the vehicle during use/operation and instead can move inside the vehicle or the interior. It is consequently possible to record images of objects/anomalies particularly flexibly from respective desired viewpoints.

In a preferred variant of this embodiment, at least one of the recording units is a recording unit hand-held by a person. It is in particular the camera of a hand-held end-user device, for example a smartphone or a tablet. It is possible to record images from different viewpoints particularly simply.

In a preferred variant of these embodiments, at least one of the recording units is a recording unit which is or can be moved at least semi-autonomously, in particular autonomously. In particular, the recording unit is fastened to a flying drone and consequently can be moved autonomously or semi-autonomously by the latter and is actually moved in this way when in use. As a result, images can be recorded in at at least partially automated fashion, for example a drone can fly autonomously through the interior and record all the objects of interest whilst the vehicle is stationary (for example, between two journeys or flights, when there are no passengers in the interior).

In a preferred embodiment, the inspection arrangement contains a display unit which is connected to one of the interfaces and is configured to display the images and/or the classification values to a user. Such a display then actually takes place during operation. The inspection arrangement furthermore contains an input unit which is connected to one of the interfaces, can be operated by the user and is configured to modify at least one of the displayed classification values or to generate an additional classification value in the inspection arrangement, this also including input into the latter. The display can here take place “online”, i.e. inside the interior, for example directly linked to the recording of images. Alternatively, there can also be a “remote” display, for example in a crew area of an aircraft or outside the aircraft, for example in an airline maintenance centre. The display can take place immediately after the image is recorded or alternatively with a deliberate time delay. The modification of the classification values can be used, for example, by a user in order to correct a false classification (for example, an automatically classified “tear” in a seat is actually “dirt”). The user can view the image/object and check and possibly change the automatically generated classification. The reentry of classification values can be either the manual assignment of a classification value known in the database to an image/object (anomaly not recognized automatically) or it is also conceivable to create a new classification, not known previously in the database, when, for example, an anomaly occurs for which no classification yet exists.

In a preferred embodiment, the inspection arrangement contains a hand-held end-user device which contains at least one of the recording units and/or—if present—the display unit and/or the input unit. Such an end-user device is in particular a smartphone, laptop or tablet computer. In particular, it is a piece of equipment which is present anyway in the interior and has additionally been given the functionality of the inspection arrangement according to the invention in the form of software/firmware. The functionality according to the invention can thus be added to a piece of equipment which is present anyway. In particular, the end-user device contains anyway, as explained above, the recording unit/camera, display unit, input unit/touchscreen, keyboard, etc such that they have to be used only within the sense of the inspection arrangement, for example by implementing a corresponding application in the end-user device.

In a preferred variant of this embodiment, part of the inspection arrangement, in particular at least part of the image recording unit (for example, except for a camera for generating image data) and/or of the database and/or of the analysis unit is therefore implemented as an application on the end-user device. The application is in particular so-called software in the form of an “app” on a smartphone or tablet computer. The corresponding functionality can thus be given to existing hardware (end-user device) particularly simply.

In a preferred embodiment, the inspection arrangement is a distributed arrangement which is split over at least two communicatively interconnected sub-devices. Thus, for example, the recording unit in the form of a camera fixedly installed in a vehicle as a first sub-device is connected in a communications-related fashion to a processing unit (database and analysis unit) as a second sub-device. The processing unit can here also be arranged in the vehicle or alternatively remotely from it, for example in a stationary ground station. It may thus be possible to minimize the installation effort in the vehicle.

The present invention is also achieved by an inspection method for an interior of a passenger vehicle with the aid of the inspection arrangement according to the invention. In the method, at least one image of the object (possibly with the anomaly) is recorded with at least one of the recording units, wherein the object is situated in the interior of the vehicle. In particular, the interior and the vehicle are thus also recorded on the image. Furthermore, the image content of the image is analysed automatically using the database, and the classification values assigned with the aid of the assignment rules to the image and the image content and the depicted object and the depicted anomaly. The classification values assigned to the image/image content/object/anomaly, and optionally also the image, are output via at least one of the interfaces to a downstream entity or input by the latter.

The method and at least some of its possible embodiments, as well as the respective advantages, have analogously already been explained in conjunction with the inspection arrangement according to the invention.

In a preferred embodiment, in particular in conjunction with the abovementioned embodiment of the inspection arrangement with a display unit and input unit, the classification value and/or also the image are output to a user as an entity. Output at the same time is a request to the user to review the in particular automatically calculated classification value. The request is also made to possibly input a corrected or additional classification value via one of the interfaces.

In a preferred embodiment, the inspection method is carried out during operation of the interior for passenger transport. Such operation is a journey or flight of the vehicle for the purpose of passenger transport. For example, the method is carried out when a passenger makes the onboard personnel of a vehicle aware of damaged or non-functional objects. The corresponding anomaly/deficiency is recorded, classified and, for example, relayed to a control centre with the aid of the inspection arrangement as early as when in flight or during the journey. The onboard personnel are thus relieved of the time-consuming task of manually recording the deficiency (for example, making a written note) and manually passing it on (notifying the control centre in writing with the note) to a downstream entity (for example, control centre). Moreover, the deficiency can be repaired, for example, as early as at the next stop/end of the journey/landing.

The invention is based on the following insights, observations and considerations and also has the following preferred embodiments. These embodiments are here also referred to, in a partly simplified fashion, as “the invention”. The embodiments can here also contain parts or combinations of the abovementioned embodiments or correspond to them and/or possibly also include embodiments not already mentioned.

The invention is based in particular on the idea of seeking options for relieving personnel such as, for example, the cabin crew, the cabin inspection team and the maintenance engineers from routine tasks and for increasing the quality and reliability of the inspections. At the same time, it is desirable to make considerable cost savings by avoiding misinterpretations and required training.

The invention is based in particular on the idea of recording an optical image of the facilities (interior with objects) by means of a piece of detection equipment (mobile or stationary, containing the recording unit). This can take place in different spectral ranges. This recording is evaluated in particular using suitable analysis methods (an analysis unit in conjunction with a database) with respect to the deviation (actual anomalies on objects) from the standard state (known object with no anomaly). The result of the analysis is presented to the user or relayed to further data processing facilities (via interfaces at a downstream entity).

The invention can prevent premature replacement of parts and assist the systematic recognition of anomaly/damage patterns in a larger fleet of vehicles. The data help to enable, inter alia, the early development of repair methods before large-scale replacement with new parts is required. Subjective assessment by the person doing the inspection is made objective.

Errors, missing information and interpretability at the operator interface of the vehicle, for example airline (interior with objects)/supplier (producer of the objects or replacement parts for the latter, etc), are avoided by in particular systematic detection and standardized data (fixed assignment rules, automatic assignment).

Airlines, etc (vehicle operators/owners) regularly experience that the (in-flight) travel experience for passengers in the vehicle is adversely affected by impaired or non-functional cabin products (objects). This can thus be avoided.

According to the invention, functional checks on electrical systems can be largely dispensed with and corresponding reductions in personnel costs are possible. Automated recognition of these anomalies/defects (on objects) also results in prompt repair. The number of open anomalies/defects which affect the comfort of passengers is thus immediately reduced. Automated checking via the taking of images, in particular digital images, and the recognition of anomalies/defects (assignment of classification values) by machine-learning approaches (in particular the interaction of the database and analysis unit) can directly reduce the effort required by personnel and enable an objective definition of acceptance criteria (assignment rules/classification values).

According to the invention, there is in particular a camera-based system (recording unit: camera) for recognizing anomalies/damage (on objects) in the cabin (interior), taking into account multiple possible target platforms (inspection arrangement, for example, mobile-based (tablet computer, laptop, smartphone, . . . ) or as a fixedly installed system) including the required recognition algorithms for anomalies/damage, the classification thereof and the recommended actions derived therefrom (analysis unit with database, possibly in the downstream entity). The system furthermore comprises the simple expansion of the recognition database by it assisting the classification of new anomalies/damage (input via the interface, machine learning).

According to this invention, there is in particular an automatic (assignment rules) and guided (request to review) inspection of interiors. An anomaly/the defective state of surfaces, equipment is recognized, classified, in particular assigned and a recommended action generated with the aid of recognition equipment (inspection arrangement) and in particular logging also takes place. This automatic inspection is interesting in particular in the passenger aircraft, train and bus sector.

Part of the invention is implemented in particular as an application (a so-called “app”) on a hand-held end-user device. The app is configured in particular as follows:

It serves to detect anomalies/damage. The user starts the app and inputs the basic information (for example, identifier of a vehicle, tail number, its ID or the equipment ID of the recording unit is used). The app is in particular restricted to landscape format of a non-quadratic display unit and hence the images are always in the same format.

The user receives the camera view (settings of the native app or link to the camera app) and additionally a series of input fields/buttons for the data. The user can record an image by inputting a command (for example, “Capture” button). Multiple images (of the same object/anomaly) can also be recorded each time.

The buttons are in particular pop-ups, depending on the evolutionary stage. In a first stage, text input or a drop-down menu with known values is possible. In further stages, this is replaced by further automatically generated information which can be further manipulated by the operator/user.

Once the information has been filled out, the operator chooses a start value from a drop-down menu with the preselection. The operator can, however, choose a different value. The operator value is then applied.

The buttons represent the required information: for example, “Problem” has the selection options “Tear/Dent/Dirt/Paint damage/Scratch”. “Class” enables classification by airline, “Fixpoint” offers the selection options “Immediate/Maintenance/C check”. For “Location”, the location can be chosen from a layout.

When the information has been entered, the user pushes, for example, an “OK” button. The information is then saved, either directly online or in the file system, a database for offline processing.

After saving, the user can decide whether they would like to finish the walk through the interior (Cabin Walk) or to continue it, i.e. would like to record a further anomaly.

In an expansion stage, after a photo has been captured, the option of marking the anomaly/problem (locational marking in the image, for example using flat colour or circles) can also be offered. The marking is placed as an overlay on the image (original image remains unchanged).

Images which find use in the context of the inspection arrangement and the inspection method should have the following properties: the image should show the object in its operational setting: i.e. no images of objects with extraneous material such as, for example, packaging material or no images of objects in isolation. There should be no additional markers/indicators for the anomaly, i.e. no stickers, no pointing fingers, no drawn marking lines. The image should have high contrast and high resolution because the anomalies on the object are usually very small. The whole of the object should be visible, i.e. not a detail of the object. The image should reflect different cabin designs, in particular colours, material, design. The image should reflect different light situations, i.e. internal light, external light, sunny or cloudy setting. Images of an object should be recorded from different viewpoints.

The classification values are in particular: Crack, Seal, Surface, Stain/Contamination/Dirt, Scratch, Discoloration, and OCR failure message.

Image attributes for characterizing the images are in particular: Originator in order to identify the image owner, recording date, vehicle type, vehicle identifier, classification value, object (seat, covering, . . . ), part numbers and part modification standards are desirable, recording location in the vehicle, visibility for a passenger, classification as essential equipment of the interior, maintenance status (planned, not planned, date of last maintenance).

### BRIEF DESCRIPTION OF THE DRAWINGS

Further features, actions and advantages of the invention can be found in the following description of a preferred exemplary embodiment of the invention and the attached Figures, in which, in each case shown schematically:

FIG. 1 shows a passenger cabin of an aircraft with symbolic recording units,

FIG. 2 shows a block diagram of an inspection arrangement,

FIG. 3 shows an end-user device with a screen view of an app of the inspection arrangement with its login screen,

FIG. 4 shows the recording screen,

FIG. 5 shows the save screen,

FIG. 6 shows an alternative save screen with marking selection, and

FIG. 7 shows the marking screen.

### DETAILED DESCRIPTION OF THE INVENTION

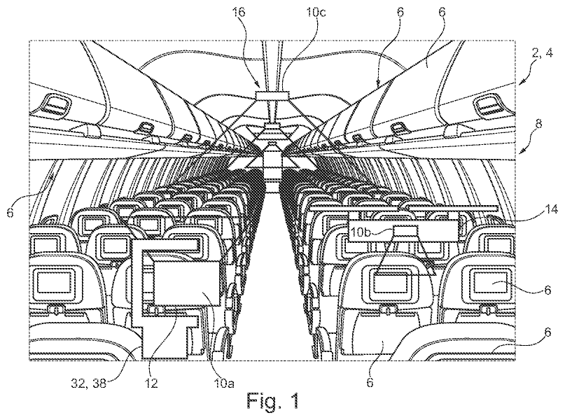

FIG. 1 shows a detail of a passenger aircraft 2, in this case a passenger aircraft, namely a detail of its interior 4, in this case its passenger cabin. The interior 4 contains a large number of objects 6, in this case in the form of passenger seats, folding tables, screens, overheard storage compartments (OHSCs), covering panels, interior lighting (indirect, hidden, behind the panels), etc, only some of which are labelled with reference signs by way of example in FIG. 1.

The vehicle 2 contains an inspection arrangement 8. In the example, it comprises three image recording units 10a-c which are indicated only symbolically in FIG. 1. The recording unit 10a is a camera of a tablet computer 12 and hence is distinguished as being mobile and hand-held. A hand 38 of a user 32 is indicated here. The user is here a member of the cabin crew who carries the tablet computer 12 with them anyway, for example in order to take orders (meals, drinks, . . . ) from passengers. The recording unit 10b is a camera fastened to a drone 14 and hence is also distinguished as being mobile and additionally as being autonomously movable. The recording unit 10c is a camera in a stationary camera module 16 attached fixedly to the ceiling of the interior 4 and hence is distinguished as being stationary.

The recording unit 10c is thus a recording unit which can be attached fixedly in the vehicle 2 as specified and is attached here. The recording units 10a,b are recording units which can be deployed movably in the vehicle 2. The recording unit 10a is a recording unit which is moved by hand. The recording unit 10b is a semi-autonomously movable recording unit.

Further components of the inspection arrangement 8 are not illustrated in FIG. 1.

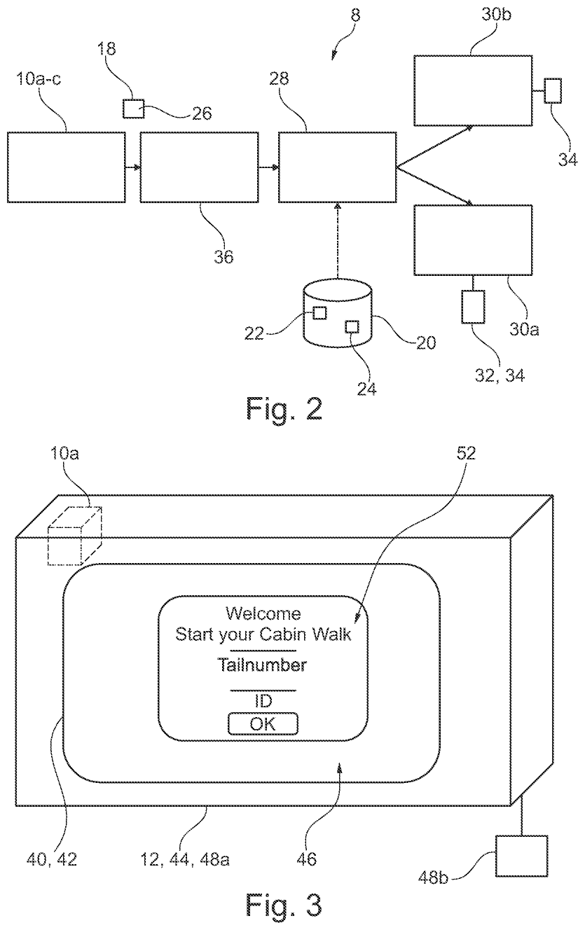

FIG. 2 shows a block diagram of the inspection arrangement 8. The image recording units 10a-c serve to capture images, i.e. to generate or record images 18 of the interior 4 of the vehicle 2. As specified, at least parts of the objects 6 on which an anomaly or an error, a defect, or the like has been found are depicted on the images 18.

The inspection arrangement 8 furthermore contains a classification database 20. This in turn contains classification values 22 for at least one of the objects 6 and assignment rules 24. The latter serve to assign the classification values 22 to specific image contents 26 of the images 18 in which objects 6 are depicted. The image contents 26 here show the abovementioned anomalies on the objects 6.

The inspection arrangement 8 furthermore contains an image analysis unit 28 which is connected communicatively or in a communications-related fashion, i.e. for data exchange, to the database 20. The analysis unit 28 is configured to automatically analyse the images 18 for the image contents 26 and to assign classification values to the images 18 with their image contents 26 according to the assignment rules 24. The classification value 22 is thus also assigned to the object 6 which represents the image content 26 or is represented by the latter.

The inspection arrangement 8 furthermore contains two interfaces 30a,b. The interface 30a is a user interface for a user 32. It serves to communicate the analysis results of the analysis unit 28 (images 18, assigned classification values 22, . . . ) to the user 32. It moreover enables the user 32 to input into the inspection arrangement 8 for example modified or new classification values 22/images 18/image attributes, etc. The interface 30b is a system interface for a data processing system (entity 34) downstream from the inspection arrangement 8 and indicated only symbolically. Both the user 32 and the data processing system thus in each case form a downstream entity 34 for the inspection arrangement 8.

The inspection arrangement 8 moreover contains an image processing unit 36 connected between the recording unit 10a-c and the analysis unit 28. It is configured to subject the images 18 recorded by the recording unit 10a-c to image processing before they are transmitted to the analysis unit 28.

FIG. 3 shows, again indicated symbolically, the tablet computer 12 moved by the hand 38 of the user 32. It contains the image recording unit 10a in the form of its integrated camera. In addition, it contains a display unit 40 in the form of a screen/display. The display unit 40 is configured to display the images 18 and the classification values 22 to the user 32. The tablet computer 12 moreover contains an input unit 42. In the example, the latter is formed by the screen being configured as a touchscreen. The input unit 42 can therefore be operated by the user 32 and is configured to be able to modify at least one of the displayed classification values 22 or to generate an additional classification value 22 in the inspection arrangement 8.

The tablet computer 12 thus represents a hand-held end-user device 44 of the inspection arrangement 8 which contains the recording unit 10a in the form of the installed camera and the display unit 40 and the input unit 42.

Part of the inspection arrangement 8, in this case inter alia the processing unit 36, the display unit 40, and the input unit 42, is implemented as an application 46 on the end-user device 44. The application 42 is a so-called “app” for an operating system of the tablet computer 12. The end-user device 44 represents a first sub-device 46a of the inspection arrangement 8. It communicates with a second sub-device 46b of the inspection arrangement 8 which is indicated only symbolically in FIG. 3 and is actually a data processing facility in a remote base station. The inspection arrangement 8 is thus a distributed arrangement which is split over the two sub-devices 46a,b.

FIG. 3 shows a starting screen of the application 46 which serves for capturing anomalies/damage in the interior 4 on the objects 6. The starting screen appears after the application 46 has started. The user 32 can here input the basic information, namely in the “Tail number” field 52 the identifier of the aircraft in which they are situated, and in the “ID” field 52 an identification number which identifies them as the person recording the relevant anomaly or identifies the recording device (then the ID of the computer 12, possibly inserted automatically). The user can complete the inputs using an “OK” button 52. The application 46 is always illustrated in landscape on an end-user device 44 or its display unit 40. Thus, recorded images 18 also always have the same format.

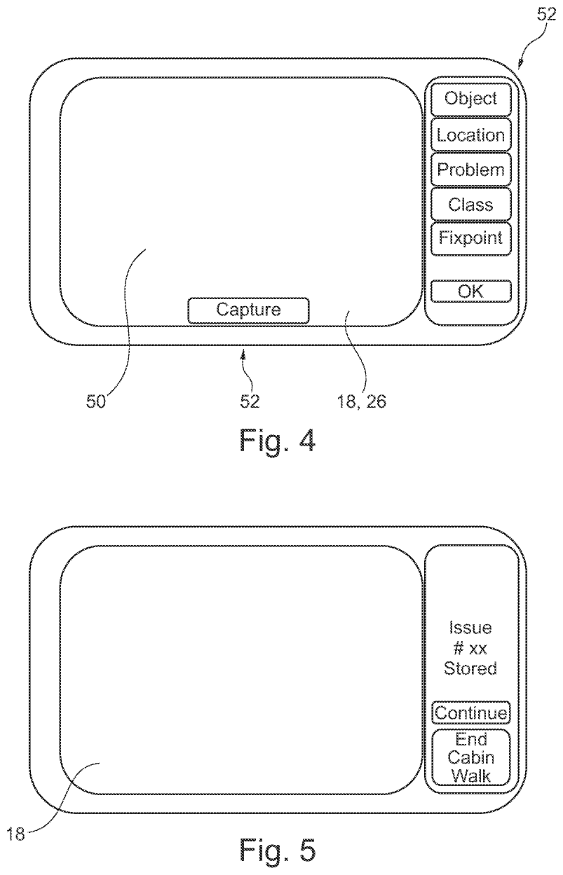

FIG. 4 shows, as in the other Figures, only the display unit 44, i.e. the screen, and on it the next camera view 50 (live image of the recording unit 10a) and a row of fields/buttons 52 which are displayed to the user 32. The user can record a picture via the “Capture” field 52, i.e. generate an image 18 which is then displayed.

The inspection arrangement then assigns classification values 22, in this case a tear on a depicted seat, to the image content 26 of the image 18 according to the assignment rules 24.

The buttons 52 are pop-ups, and depending on the evolutionary stage text input or a drop-down list of known values are possible. In later stages, this is replaced by automatically generated information which can be manipulated again by the operator. The user 32 can select the depicted object, in this case a seat, using “Object”. With “Location”, they can specify the location of the object, in this case a location from a layout, in this case “seat 28A”. With “Problem”, the problem which has been found is defined, i.e. the “Tear”. With “Class”, a classification is specified according to the airline, in this case “Visible for the passenger” because the tear is on the sitting surface. With “Fixpoint”, timing of the repair is specified, in this case “Immediate” because the tear needs to be repaired as soon as possible. In the event that the classification value 22 “Scratch” has been set automatically erroneously, the user 32 can change it to the correct value “Tear” using the drop-down list.

Once the information has been captured, the user pushes the “OK” button 52. The information is then saved, in this case offline in a memory in the sub-device 48b. A message “Issue” Nr. XX (error number which is then allocated) appears and confirms that the information has been saved.

FIG. 5 shows the screen after saving. The user can then decide whether they end the walk through the cabin (“End Cabin Walk” button 52) or continues it (“Continue” button 52).

The anomaly which has been found can then be passed on by the inspection arrangement 8 for repair. Here a request for a new seat is sent with the aid of the sub-device 48b to a warehouse, the seat is supplied to the location where the aircraft 2 will land next, and, when it lands next, the damaged seat is replaced immediately with the new one.

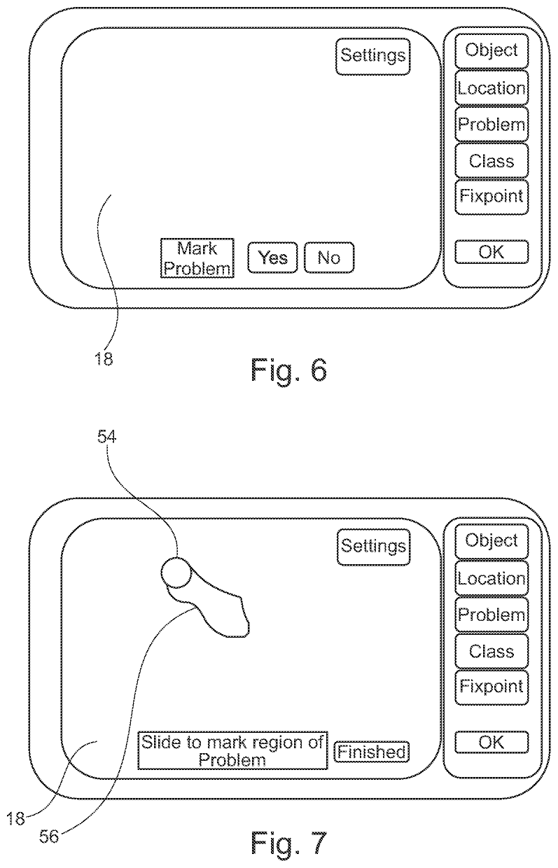

FIG. 6 shows an extension stage of the application 46 in which further information can be captured via a “Settings” button 52. Here the “Mark Problem” function is selected, in which further marking of the anomaly/problem in the image 18 can take place (“Yes”) or not (“No”).

FIG. 7 shows the procedure when marking the problem in the image 18. A circle 54 symbolizes the point at which the finger of the user 32 is currently placed (touch point). A marking location 56, in this case a marking area, is the location, in this case the region, which the user 32 has already marked by moving their finger over the touchscreen (input unit 42). The marking location 56 denotes the location of the problem which has been found, in this case the anomaly in the form of the tear, in the image 18. The marking 56 is placed/saved as an overlay on the image 18 and the original image 18 remains unchanged. The user ends the marking procedure using the “Finished” button 52. The “Slide to mark region of Problem” help information of the application 46 provides a corresponding user tip for the user 32.

### LIST OF REFERENCE SIGNS

2 (passenger) vehicle
4 interior
6 object
8 inspection arrangement
10a-c (image) recording unit
12 tablet computer
14 drone
16 (stationary) camera module
18 image
20 (classification) database
22 classification value
24 assignment rules
26 image content
28 (image) analysis unit
30a,b interface
32 user
34 entity
36 (image) processing unit
38 hand
40 display unit
42 input unit
44 hand-held end-user device
46 application
48a,b sub-device
50 camera view
52 fields/buttons
54 circle
56 marking location

What is claimed is:

1. An inspection arrangement for an interior of a passenger vehicle, wherein the interior contains an object,
with at least one image recording unit which is configured to record an image of the interior of the vehicle with the object,
with a classification database which contains classification values for at least one of the objects and assignment rules for assigning the classification values to specific image contents, depicting the objects, of images,
with an image analysis unit which is communicatively connected to the database and is configured to automatically analyse the images in terms of their image contents and to assign the classification values to the objects represented by them according to the assignment rules,
with at least one interface for the input and/or output of the classification values assigned to the images and/or of the images from and/or to a downstream entity.

2. The inspection arrangement according to claim 1, wherein the classification value is one of the following:
an object value identifying one of the objects,
a location value describing a location of the object in the interior,
a problem value describing a problem on the object,
a problem classification value classifying the problem,
a repair value correlated with the repair of the problem on the object,
an image attribute value describing an attribute of the image,
an image marking describing a marking location in the image.

3. The inspection arrangement according to claim 1, wherein the inspection arrangement contains an image processing unit which is interposed between the recording unit and the analysis unit and is configured to carry out image processing on the images generated by the recording unit before the processed images are transmitted to the analysis unit.

4. The inspection arrangement according to claim 1, wherein at least one of the recording units is a recording unit which is to be fixedly attached in the vehicle as specified.

5. The inspection arrangement according to claim 1, wherein at least one of the recording units is a recording unit which can be deployed movably in the vehicle.

6. The inspection arrangement according to claim 5, wherein at least one of the recording units is a hand-held recording unit.

7. The inspection arrangement according to claim 5, wherein at least one of the recording units is a recording unit which can be moved at least semi-autonomously.

8. The inspection arrangement according to claim 1, wherein the inspection arrangement contains:
a display unit which is connected to one of the interfaces and is configured to display the images and/or the classification values to a user,
an input unit which is connected to one of the interfaces, can be operated by the user and is configured to modify at least one of the displayed classification values or to generate an additional classification value in the inspection arrangement.

9. The inspection arrangement according to claim 1, wherein the inspection arrangement contains a hand-held end-user device which contains at least one of the recording units and/or—if present—the display unit and/or the input unit.

10. The inspection arrangement according to claim 9, wherein at least part of the inspection arrangement is implemented as an application on the end-user device.

11. The inspection arrangement according to claim 1, wherein the inspection arrangement is a distributed arrangement which is split over at least two communicatively interconnected sub-devices.

12. An inspection method for an interior of a passenger vehicle with the aid of the inspection arrangement according to claim 1, in which:
recoding at least one image of the object of the interior of the vehicle with at least one of the recording units,
analyzing the image in terms of the image content automatically using the database by the analysis unit, and assigning the classification values with the aid of the assignment rules to the image content and hence to the image and to the object,
outputting the classification values assigned to the image, and optionally also the image, via at least one of the interfaces to a downstream entity and/or input by the latter.

13. The inspection method according to claim 12, wherein the classification value and/or also the image are output to a user as an entity with a request to a user to review the classification value and possibly input a corrected or additional classification value via one of the interfaces.

14. The inspection method according to claim 12, wherein the inspection method is carried out during operation of the interior for passenger transport.
